(19) United States
(12) Patent Application Publication
(10) Pub. No.: US 2018/0158165 A1
(43) Pub. Date: Jun. 7, 2018

(54) SYSTEM AND METHOD FOR UNIFIED INMATE INFORMATION AND PROVISIONING

(71) Applicant: GLOBAL TEL*LINK CORP., Reston, VA (US)

(72) Inventor: Stephen L. HODGE, Aubrey, TX (US)

(21) Appl. No.: 15/366,748

(22) Filed: Dec. 1, 2016

(51) Int. Cl. G06Q 50/26; H04L 29/08; G06F 17/30; G06K 9/00

(52) U.S. Cl. CPC G06Q 50/265; H04L 67/22; G06F 17/30696; G06K 9/00228; G06F 17/30247; G06K 9/00288; G06F 17/30702

(57) ABSTRACT

The present disclosure provides details of a system and method unified inmate information and activity tracking and monitoring. Such a system may collect and organize information received from different authorized facilities. The unified inmate information system connects information between different authorized facilities and utilizes the information to respond to requests that aid the course of an investigation. Responding to requests may include generating reports, searching the database for matching images or data obtained from a crime scene or other criminal activity, or detecting patterns of behavior that may aid in predicting potential crimes or associations between inmates.

### BACKGROUND

### Field

The disclosure relates to a system and method for unified inmate information and activity tracking and monitoring.

### Background

Police, county, state, and federal officials routinely seek information regarding a suspect that may be relevant to on-going investigations, especially if the suspect has been previously incarcerated and is already in the “system.” Unfortunately, such information is generally located in disparate facilities in which the suspect has been processed. For example, an arrested individual may be booked at a police station, and may then be transferred to another facility, such as a prison or correctional facility. The arrested individual could then be transferred to yet another facility. Each of these facilities may collect certain information about inmates but there is currently no system or method for unifying the information that are stored across different facilities.

Storing such information in this disjointed manner increases the burden for police, county, state, and federal officials who seek and rely on the information in their investigations. Officials must separately contact or request information from each facility that has information regarding any potential suspect or suspects, collect the information, and undergo the arduous task of analyzing the collected information to determine any useful connections or data for the investigation.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1A illustrates a block diagram of a unified inmate information system, according to embodiments of the present disclosure.

FIG. 1B illustrates a block diagram of a unified inmate information system, according to embodiments of the present disclosure.

FIG. 2 illustrates a block diagram of service center, according to embodiments of the present disclosure.

FIG. 3 illustrates a flowchart diagrams of methods of tracking and providing a unified inmate information system, according to embodiments of the present disclosure.

FIG. 4 illustrates a flowchart diagrams of methods of tracking and providing a unified inmate information system, according to embodiments of the present disclosure.

FIG. 5A illustrates a flowchart diagrams of methods of tracking and providing a unified inmate information system, according to embodiments of the present disclosure.

FIG. 5B illustrates a flowchart diagrams of methods of tracking and providing a unified inmate information system, according to embodiments of the present disclosure.

FIG. 6 illustrates a computer system, according to exemplary embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the tell “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

As discussed above, information regarding inmates are generally located across disparate and unconnected databases of correctional facilities and jails. The information collected by these different facilities are not connected, which limits the capabilities of investigators when investigating an inmate or inmates that are located in different jails.

In light of the above, the present disclosure provides details of a system and method for unified inmate information and activity tracking and monitoring. Such a system may collect and organize information received from different authorized facilities. Such information may include, but is not limited to, information regarding an inmate's activities within a prison, personal information, physical characteristics, DNA information, biometric information such as facial images, infrared images, fingerprints, and recorded voice data, interactions with other inmates, visitation history, emails sent from devices within facilities, text message sent from devices within facilities, recorded voice calls, called parties, recorded video visitations, and incoming calls (i.e., calling parties). This information may be collected by officials at the time an inmate was booked at a police station (e.g., fingerprint, voice data, image), by officials at the time an inmate is processed at a prison (e.g., fingerprint, voice data, image), through active tracking and monitoring of an inmate's usage of facility-provided devices such as mobile devices, and through passive tracking and monitoring of an inmate's behavior or interactions with other inmates or during visitations.

The unified inmate information system connects information between different authorized facilities and utilizes the information to respond to requests that aid the course of an investigation. Responding to requests may include generating reports, searching the database for matching images or data obtained from a crime scene or other criminal activity, or detecting patterns of behavior that may aid in predicting potential crimes or associations between inmates.

### Unified Inmate Information System

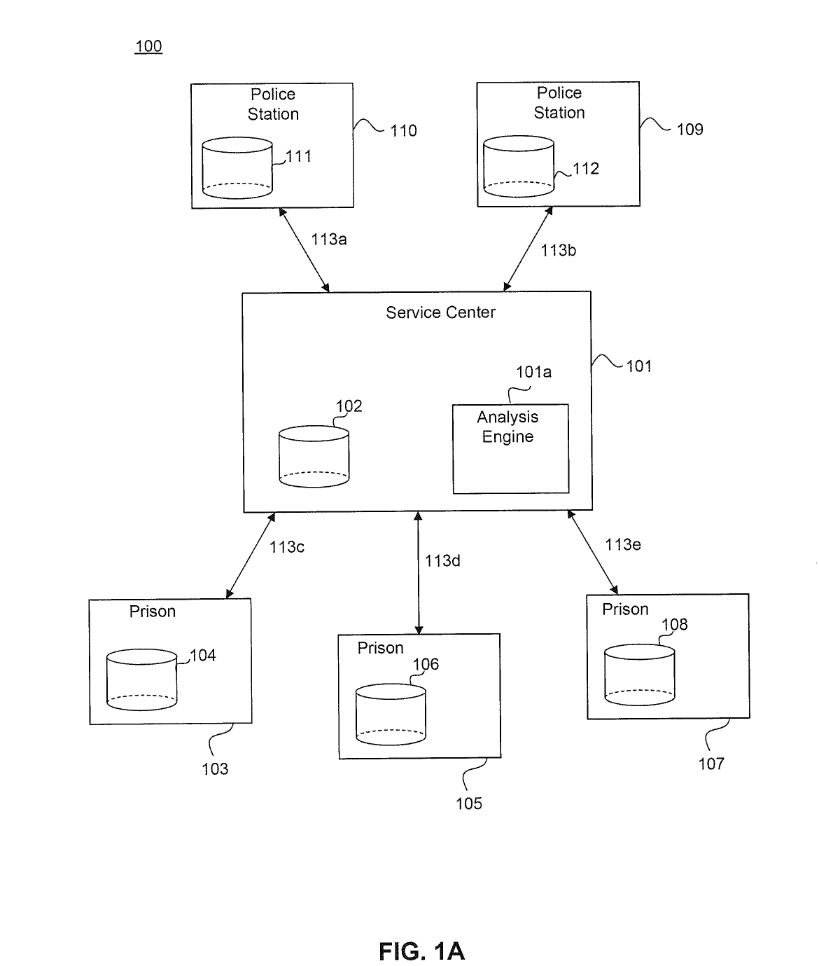

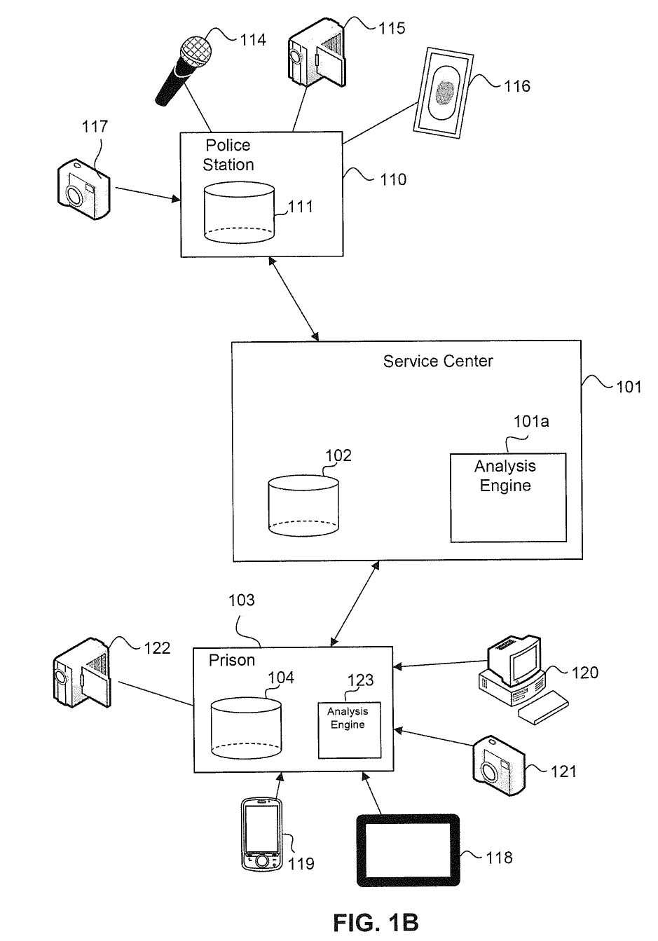

FIG. 1A illustrates a block diagram of a searchable unified inmate information system 100, according to embodiments of the present disclosure. In an embodiment, as shown by FIG. 1A, unified inmate information system 100 includes a number of prisons 103, 105, and 107 and police stations 109 and 110 connected to service center 101 through connections 113a-e. In particular, police stations 109 and 110 is connected to service center 101 through separate connections 113a and 113b, respectively. Prisons 103, 105, and 107 is connected to service center 101 through separate connections 113c, 113d, and 113e, respectively. Connections 113a-e is wired (e.g., Ethernet) or wireless connection, where the wireless connection is implemented as a wide-area network (WAN) connection, local area network (LAN) connection, the Internet, a Bluetooth connection, or an infrared connection. Other types of implementations for a wired or wireless connection are possible without deviating from the scope of the invention. The components of unified information system 100 may all include databases for storing inmate information. For example, prison 103 includes database 104, prison 105 includes database 106, and prison 107 includes database 108. Police station 109 includes database 112 and police station 110 includes database 111. Service center 101 includes database 102. Databases 102, 104, 106, 108, 111, and 112 may be implemented as a server, multiple servers, a centralized storage area network (SAN), or any other configuration of storage devices.

Service center 101 serves as a searchable unified repository for all inmate information that are provided by all facilities connected to service center 101. In the embodiment of FIG. 1A, prisons 103, 105, and 107, and police stations 109 and 110 each store separate inmate information in their respective databases and provide all inmate information to database 102. In this manner service center 101 aggregates all available information from across different facilities that are not traditionally connected. Although prisons and jails are depicted in FIG. 1A, one of ordinary skill in the art would understand that other types of facilities which collect and store inmate information are within the scope of the invention, and may be implemented in addition to prisons and jails. Service center 101 may be accessible to any facility that has been authorized by service center 101.

Further in the embodiment of FIG. 1A, information provided by prisons 103, 105, and 107 includes information stored in databases 104, 106, and 108 regarding inmates such as biometric information regarding inmates such as fingerprints, voice recordings, two-dimensional (2-D) facial images, and three-dimensional (3-D) facial images, gang-related information, and physical marks regarding inmates such as scars, gang-related tattoos and symbols. Other inmate information may include personal information such as name, passwords, date of birth, and social security numbers as well as inmate behaviors such as call records/history and called party information such as called party name and addresses. Information may also be directed to parties with whom inmates are associated such as visitors, other inmates (both within the same prison or in other prisons), gang members, and family. This information may take the form of recorded calls, recorded video sessions, recorded video visitation, recorded audio sessions, text messages, emails, and any other information that becomes available to the prison that can be stored within the system and is related to an inmate or even an employee of the prison.

Information stored in any of the databases of unified inmate information system 100 are encrypted and accessible by authorized facilities or agencies. Information transmitted to and from service center 101 is encrypted to ensure security of the transmitted information, to protect the privacy of the inmates, and so that authorized facilities or agencies can access the information to which they are authorized. In one embodiment of the present disclosure, facilities or agencies subscribe to a service that allow them access to service center 101. Authorized facilities or agencies may only be allowed access to certain types of data. For example, prisons may be limited to access the information to which it has uploaded unless granted permission by other facilities or agencies. Investigative agencies may allowed access to a wide scope of information in the course of its investigation. Authorized facilities or agencies are allowed to establish connections with service center 101 and allowed access to the searchable inmate information within database 102. There may be different types of authorized facilities or agencies that may access service center 101. For example, authorized facilities may include, but are not limited to police stations, county prisons, state prisons, federal prisons, and federal investigative agencies.

Information provided by police stations 109 and 110 to service center 101 for storage in database 102 may include the same information discussed above with respect to prisons 103, 105, and 107. Police stations 109 and 110 may also collect additional data when initially processing the arrested individual during booking. For example, police station 109 could store an image, a fingerprint, a writing sample (e.g., a signature), and other information regarding the arrested individual. In one embodiment of the present disclosure, police station 109 can provide other information such as a voice sample (e.g., from a microphone spoken into by the arrested individual during booking) and/or recorded telephone calls placed by the arrested individual.

Further in the embodiment depicted in FIG. 1A, service center 101 also contains analysis engine 101a, which processes and organizes inmate information received from one or more connected facilities. Analysis engine can be implemented using one or more servers for receiving and decrypting the inmate information received from, for example, prisons 103, 105, and 107, and police stations 109 and 110. Analysis engine 101a also can be responsible for responding to requests that are submitted to service center 101 by a connected facility. For example, in the course of an investigation, police station 109 may submit an inquiry regarding one or more potential suspects though connection 113b to service center 101. In conventional systems, information regarding the potential suspects are scattered across databases in different facilities (i.e., different jails or prisons). Thus, in conventional systems, police station 109 would have to submit separate inquiries to the different facilities, collect the information, and analyze the collected information.

In an embodiment, analysis engine 101a is responsible for correlating the received information with existing information regarding the inmate that is already stored in database 102. For example, analysis engine 101a stores the received information in an inmate profile that was previously generated and contains all of the inmate's information. If a profile of the inmate does not exist in database 102, analysis engine 101a generates a new profile for the inmate and stores the received information in the generated profile. Analysis engine 101a can also generate a unique identifier for the inmate that is associated with the inmate and the inmate's profile. Analysis engine 101a can provide unique identifiers to all authorized facilities.

Database 102 is searchable. For example, service center 101 can receive the inquiry from police station 109 and provide the inquiry to analysis engine 101a for further processing. If the suspect was previously an inmate of a facility within unified inmate information system 100, the inquiry may include the unique identifier. Analysis engine 101a can then determine the information that is requested by the inquiry, retrieve the information from database 102, and perform any further analysis of the retrieved information if requested by the inquiry. For example, if the inquiry is in regard to potential criminal activity with other suspects, analysis engine 101a can parse the inmate's information in database 102 and generate a report about the inmate including information relevant to the inquiry such as all of the inmate's relevant call records, text messages, emails, and visitation records that are connected to the other suspects.

In another example, the inquiry can include an image such as a mug shot photo or an image from a crime scene video uploaded by police station 109. Service center 101 routes the inquiry to analysis engine 101a, which uses the image to search database 102 for a match. Because database 102 has information from multiple sources and disparate facilities, police station 109 only needs to submit a single inquiry to service center 101, which increases the efficiency of the criminal investigation.

FIG. 1B illustrates a block diagram showing additional details of the elements described with respect to FIG. 1A. Only police station 110 is depicted in FIG. 1B for simplicity but the following discussion also applies to police station 109. In an embodiment, police station 110 includes a variety of input devices for obtaining information from an arrested individual. For example, police station 110 has camera 117 configured for taking 2-D or 3-D images, microphone 114 configured for recording audio such as an arrested individual's voice, video camera 115 configured for recording video, and fingerprint sensor 116 configured for obtaining fingerprints. Other types of input devices are possible for the purpose of obtaining information, including biometric data, physical data, and writing samples, from the arrested individual. Such information can be obtained when an arrested individual is booked at police station 110. After obtaining all relevant information regarding the arrested individual, police station 110 can store the information in its own database 111 and further transmit the information to service center 101 for centralized storage in database 102. While only police stations are discussed, other facilities in which arrested individuals are initially booked are within the scope of the invention.

Only prison 103 is depicted in FIG. 1B for simplicity but the following discussion also applies to prisons 105 and 107. In an embodiment, prison 103 includes input devices for obtaining information about new and already incarcerated inmates. Such input devices include devices monitored by prison 103 and utilized by inmates during the course of their day. For example, prison 103 can provide an inmate access to tablet 118 for certain authorized activities such as browsing websites on the Internet, sending emails or text messages, or conducting video calls with family or other parties outside of prison 103. Inmate can be required to provide authorized credentials, such as a password, fingerprint, or any other security measure, to utilize tablet 118. Prison 103 can track and monitor all activities conducted on and information provided to tablet 118. For example, prison 103 can store the inmate's communications conducted through tablet 118 including all emails, text messages, voice and video calls, and websites visited, and the inmate's password or fingerprints in database 104 and forward the communications to service center 101 for centralized storage in database 102. Services for monitoring and recording authorized communications are also performed by, or on behalf of, prison 103 through an analysis engine 123, or at service center 101.

Prison 103 can also allow an inmate access to mobile device 119. Mobile device 119 may be implemented as any mobile communication device such as a smart phone, e-readers, or other portable devices that are borrowed, rented, and/or purchased by inmates or workers, such as guards, from prison 103 for communications with individuals outside of prison 103 such as families, friends, or others with whom the inmates are permitted to communicate. Mobile device 119 is configured to transmit and receive authorized communications to/from outsiders including text messages, emails, audio (i.e., phone calls), or video communications. Prison 103 can monitor and record all communications between mobile device 119 and an outside communication device (not shown). Such communications are stored in database 104 and also forwarded to service center 101 for centralized storage in database 102. Services for monitoring and recording authorized communications are also performed by, or on behalf of, prison 103 through an analysis engine 123, or at service center 101.

Prison 103 can also allow an inmate access to personal computer 120 for certain authorized activities such as browsing websites on the Internet, sending emails or text messages, or conducting video calls with family or other parties outside of prison 103. Prison 103 can track and monitor all activities conducted on personal computer 120. Prison 103 can store the inmate's communications conducted through personal computer 120 including all emails, text messages, voice and video calls, and websites visited, in database 104 and forward the communications to service center 101 for centralized storage in database 102. Services for monitoring and recording authorized communications are also performed by, or on behalf of, prison 103 through an analysis engine 123, or at service center 101.

Prison 103 can also passively monitor inmate activities through video camera 122 or camera 121. Prison 103 may utilize video camera 122 and camera 121 to monitor an inmate's in-person visitations with visitors to prison 103. Such monitoring can include images of the inmate and the visitors. These images are be stored at the prison 103 in database 104 and forwarded to service center 101 for centralized storage in database 102.

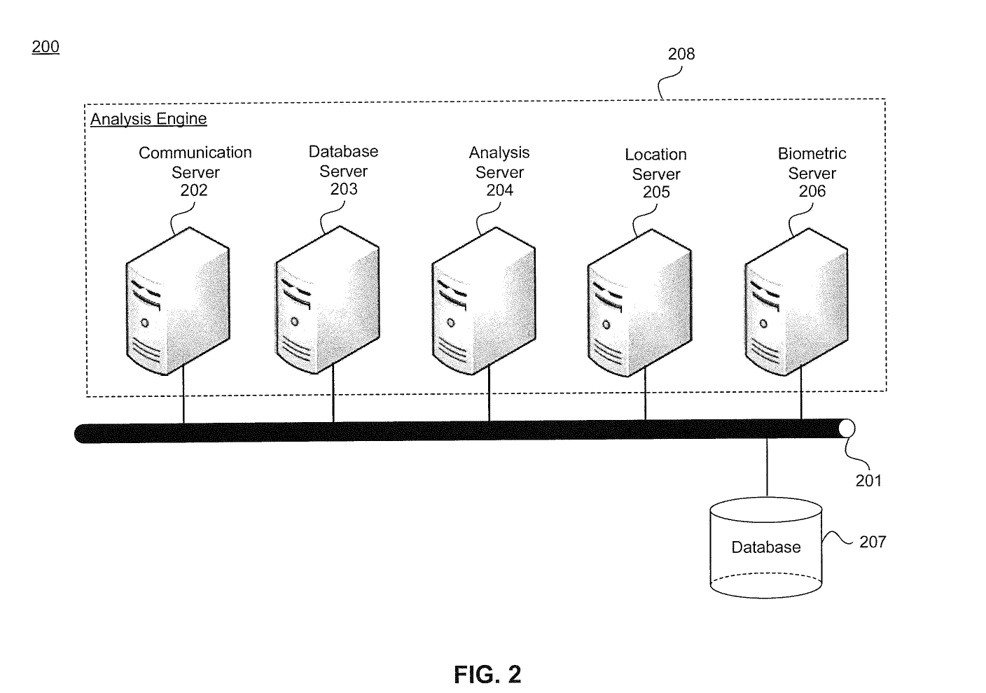

In order to monitor and record such communications, service center 101 can be configured to provide both wireless and wired communication access for tablet 118, mobile device 119, and PC 120. Wireless communication access for tablet 118 and mobile device 119 may take the form of transmissions such as GSM, CDMA, LTE, or other cellular transmissions. As will be discussed with respect to FIG. 2, in an embodiment, service center 101 contain communication servers that enable communications by devices within prisons. In another embodiment, communication servers may be disposed locally within the prisons but configured to route communications through service center 101.

### Service Center & Analysis Engine

FIG. 2 illustrates a block diagram of service center 200, according to embodiments of the present disclosure. In an embodiment, service center 200 is configured to perform the same functions described with respect to service center 101 with regard to FIGS. 1A and 1B. Service center 200 includes analysis engine 208. In an embodiment, analysis engine 208 is configured to perform the same functions described with respect to analysis engine 101a with regard to FIGS. 1A and 1B.

In an embodiment, analysis engine 208 further includes communication server 202, database server 203, analysis server 204, location server 205, biometric server 206, and database 207, all of which are connected to each other via a network bus 201. In another embodiment, the functions of communication server 202, database server 203, analysis server 204, location server 205, biometric server 206, and database 207 are implemented within a single device. In an embodiment, database 207 is configured to perform the same functions described with respect to database 102 with regard to FIGS. 1A and 1B. Each of the servers 202-206 can be constructed as individual physical hardware devices, or as virtual servers. The number of physical hardware machines can be scaled to match the number of simultaneous user connections desired to be supported by service center 300.

In an embodiment, communication server 202 consists of one or more servers, and is configured to receive and transmit information to/from one or more authorized facilities such as police stations 109 and 110 and prisons 103, 105, and 107. Communication server 202 receives information regarding inmates such as recorded audio/video data, email communications, real-time phone and video calls, images and videos, and location information. Communication server 202 can also receive inquiries from facilities requesting inmate information pertinent to an investigation. Communication server 202 forwards inquiries to analysis server 204 through network bus 201 for analysis of and generation of a response to the inquiry. Communication server 202 receives the response from analysis server 204 and forwards the response to the appropriate party.

In an embodiment, communication server 202 is further configured to perform an authentication of inquiries to determine whether the submitting facility or party is authorized to access the information located in database 207. If the facility or party is authenticated, communication server 202 continues with the inquiry process by, for example, forwarding the inquiry to analysis server 204. Moreover, communication server 202 is further configured to encrypt and decrypt all communications transmitted and received by service center 201 for security purposes. In an embodiment, a facility is authorized only to write data into database 207, only to read data from database 207, or authorized to both read data from and write data into database 207. In another embodiment, communication server 202 is configured to provide different levels of access to database 207 based on the type of facility and the type of party. Moreover, access to data within database 207 may vary based on the type of data to which access is sought. For example, one facility can be authorized only to access certain types of data into database 207, such as the data that the facility has uploaded. Another facility can be authorized to access its data as well as data provide by other facilities. The access by facilities can be limited to read only, write only, or read/write based on the type of facility, the type of data, or any other parameters related to the unified database system. For example, communication server 202 may be configured to allow read/write access to police stations and federal agencies but only write access to prisons.

In an embodiment, database server 203 consists of one or more servers, and is configured to store and organize data in database 207. Database server 203 can be configured to run a database management system, such as MYSQL™. Database server 203 interfaces with database 207 to stores information provided to service center by connected facilities such as police stations 109 and 110 and prisons 103, 105, and 107. Such information may include information about arrested individuals and past and current inmates at facilities, such as individuals booked at police stations 109 and 110, and inmates at prisons 103, 105, and 107. Database server 203 can further be configured to provide information from database 207 to connected facilities who submit inquiries. Moreover, database server 203 is configured to encrypt the information prior to storage to ensure security of the information.

In an embodiment, analysis server 204 consists of one or more servers, and functions as the primary logic processing center in unified inmate information system 100 such parsing incoming inquiries from authorized facilities, retrieving relevant information through database server 203, executing analysis based on the requested inquiry, generating reports and responses in response to the executed analysis, correlating received information with existing inmate profiles, and generating new inmate profiles. As part of its functionality to conduct analysis of inquiries based on data in database 207, analysis server 400 can further be configured to manage and facilitate communication between communication server 202, database server 203, location server 205, biometric server 206, and database 207.

Reports generated by analysis server 204 may include analytical reports and visual representations of an inmate's information such as charts illustrating an inmate's behaviors and graphs illustrating connections between an inmate and other parties or inmates. Because analysis server 204 has access to database 207, which provides unified data storage of inmates and other parties from across multiple sources, analysis server 204 is capable of detecting connections and revealing patterns between multiple parties and inmates.

In an embodiment, location server 205 consists of one or more servers, and is configured to receive and/or store location and motion data of inmates from one or more authorized facilities prisons 103, 105, and 107. Location and motion data can be obtained from tracking inmates' usage of, for example, tablet 118 and mobile device 119. In particular, the location and motion data can be provided by a global position system (GPS) function of these devices. Location server 205 is further configured to receive other location and motion data, if available, of called parties (i.e., parties called by inmates). Location server 205 can utilize the location and motion data to provide potential location and/or motion of an inmate and his known associations based on his location history, call history, and other tracked behaviors. Location information received by location server 205 can be based on any one or more of a request to one or more of an inmate's device (e.g., tablet 118, mobile device 119), a predetermined time for an inmate's device to communicate respective location and motion data, or based on an event performed by one of the inmate's device, for example detection of tablet 118 or mobile device 119. Location server 205 is further configured to provide instructions to inmate's devices to perform intervention operations based on the received location information.

In an embodiment, biometric server 206 consists one or more servers, and is configured to process and/or store biometric data of inmates. Biometric data can include any information regarding an inmate's appearance, physical characteristics, or other identifying traits that may be unique to the inmate such as voice data, facial recognition data (2D or 3D), handwriting samples, and fingerprint data. Biometric server 206 is configured to assist in analyzing audio/video data received from prisons 103, 105, and 107 and/or police stations 109 and 110. For example, biometric server 206 can compare received audio/video data against stored biometric data.

Database 207 provides access to all available inmate information provided by authorized facilities such as prisons 103, 105, and 107 and/or police stations 109 and 110. In general, database 207 stores any data stored by communication server 202, database server 203, analysis server 204, location server 205, biometric server 206. Because the data stored on database 207 may consume a significant amounts of storage space, database 207 may include a Network Attached Storage (NAS) device, which is configured as a mass storage device, or configured as a storage area network (SAN) comprising multiple storage devices. In order to reduce the required size, database 207 preferably includes a backup routine to transfer data to permanent storage devices, such as archival permanent storage or optical disks, after a predetermined time has elapsed since the initial recording of that data. Database 207 is connected to communication server 202, database server 203, analysis server 204, location server 205, biometric server 206 by way of the network bus 301.

### System Operations

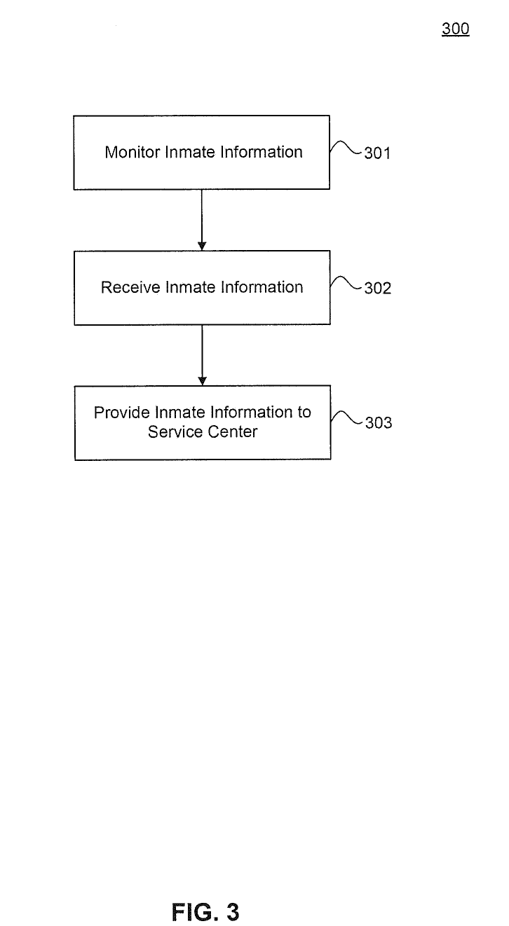

Operations of receiving and processing inmate information in unified inmate information system 100 will be described with respect to FIGS. 3, 4, 5A, and 5B. Although the physical devices and components that form the system have largely already been described, additional details regarding their operations will be described below with respect to FIGS. 1A, 1A, and 2. While FIGS. 3, 4, 5A, and 5B contain methods of operation of unified inmate information system 100, the operations are not limited to the order described below, and various operations can be performed in a different order. Further, two or more operations of each method can be performed simultaneously with each other.

FIG. 3 illustrates a flowchart diagram of a method 300 of acquiring inmate information at an authorized facility, according to embodiments of the present disclosure. In step 301, equipment at an authorized facility such as police station 109 or prison 103 monitor inmate information. Equipment can include, but are not limited to, fingerprint sensors, microphones for recording audio information, a camera for capturing 2D and/or 3D images, and a video camera. Equipment can be operated by officials of the authorized facility or operated autonomously as the inmate moves about the authorized facility. Inmate information are therefore captured automatically without requiring operation by officials. In this embodiment, equipment may always be active and waiting for inputs from tracking and monitoring inmate activities.

Upon tracking and monitoring inmate activities, the equipment receives and stores the inmate information in a local database at step 302. This step can further include additional processing of the inmate information such as storing the inmate information within an inmate profile and discarding privileged communications between the inmate and an attorney. Next, at step 303, the authorized facility provides the inmate information to a central service center.

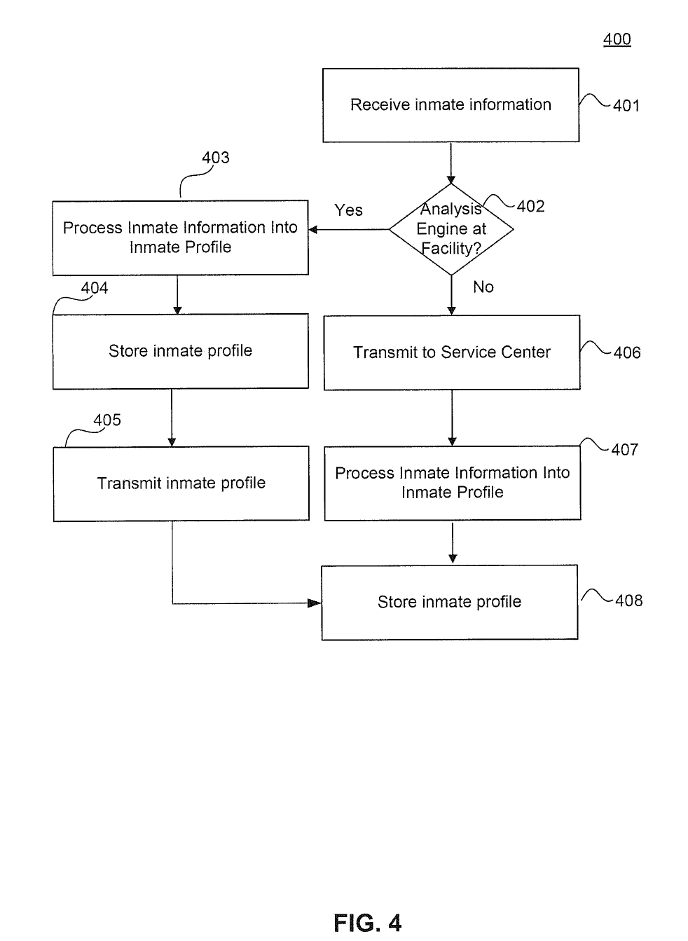

FIG. 4 illustrates a flowchart diagram of a method 400 of processing inmate information that may be performed at an authorized facility or at a service center, according to embodiments of the present disclosure. At step 401, equipment at an authorized distributed authorized facility receives inmate information as described above with respect to FIG. 3. At step 402, a determination is made as to whether an analysis engine is located at the authorized facility. An analysis engine can be located at a distributed authorized facility and a central service center, or only at the central service center, receives inmate information from equipment at the distributed authorized facility. If the analysis engine is located at both the distributed authorized facility and central service center, the analysis engine may operate in a distributed manner leveraging the computing capability at both the distributed authorized facility and the central service center.

At step 403, if an analysis engine is present at the facility, the analysis engine processes the received inmate information by organizing the information into an inmate profile. An inmate profile is a collection of all information and data associated with a particular inmate that is provided by all authorized facilities connected to the central service center. The inmate profile can include a unique identifier associated with the inmate and allows for the inmate's information to be easily accessed and retrieved when needed. This step can also include the creation of a new inmate profile if no inmate profile current exists. Creation of a new inmate profile can include generation of a unique identifier for the inmate and populating the profile with the relevant inmate information.

In an embodiment, organizing the inmate information into the inmate profile further includes categorizing the information based on the type of information. In an embodiment, the inmate information are categorized into, but not limited to, the following categories:
Biometric data such as fingerprints, facial images, and voice data, which can be acquired through sensors at the facility or agency;
Known physical characteristics such as tattoos, scars, height, and hair color, which can be acquired through observation and entered into a database at a preliminary booking;
Personal information such as social security information, family members, PINS associated with inmate accounts; and
Tracked behavior while in prison such as known associations with other inmates, identity of parties during in-person visitations, and activities on prison-issued devices (e.g., mobile devices, tablets, or PCs) such as recorded video visitations, emails, recorded voice calls, numbers and identification of called parties, numbers and identification of calling parties, text messages, calling history, and browsing history.

At step 404, the updated inmate profile is stored locally at the authorized facility. At step 405, the authorized facility transmits the updated profile for storage within a database at central service center.

Referring back to step 402, if it is determined that the authorized facility does not have an analysis engine, the inmate information is transmitted to the central service center 406, where the analysis engine at the central service center performs the steps of processing the inmate information into the inmate profile at step 407. In an embodiment, the analysis engine located at the central service center performs the same steps described above with respect to the analysis engine located at the authorized facility. Once the analysis engine of the central service center completes processing the inmate information, the updated inmate profile is stored in a database at the service center at step 408.

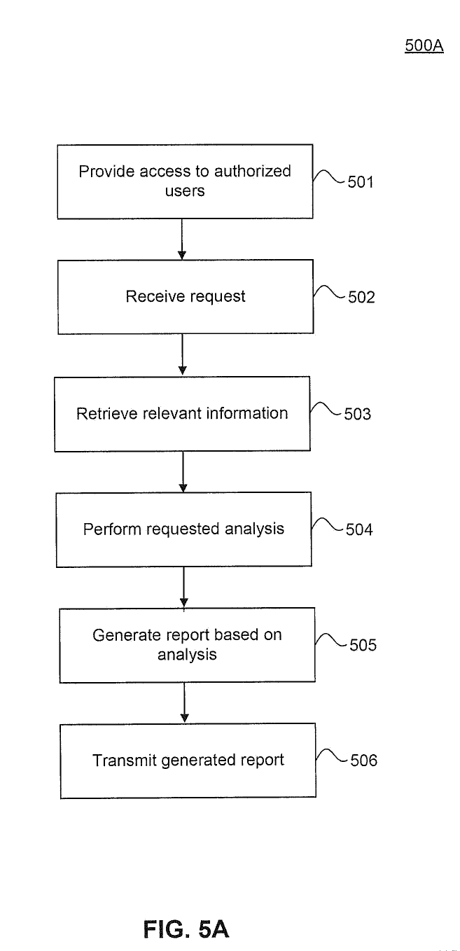

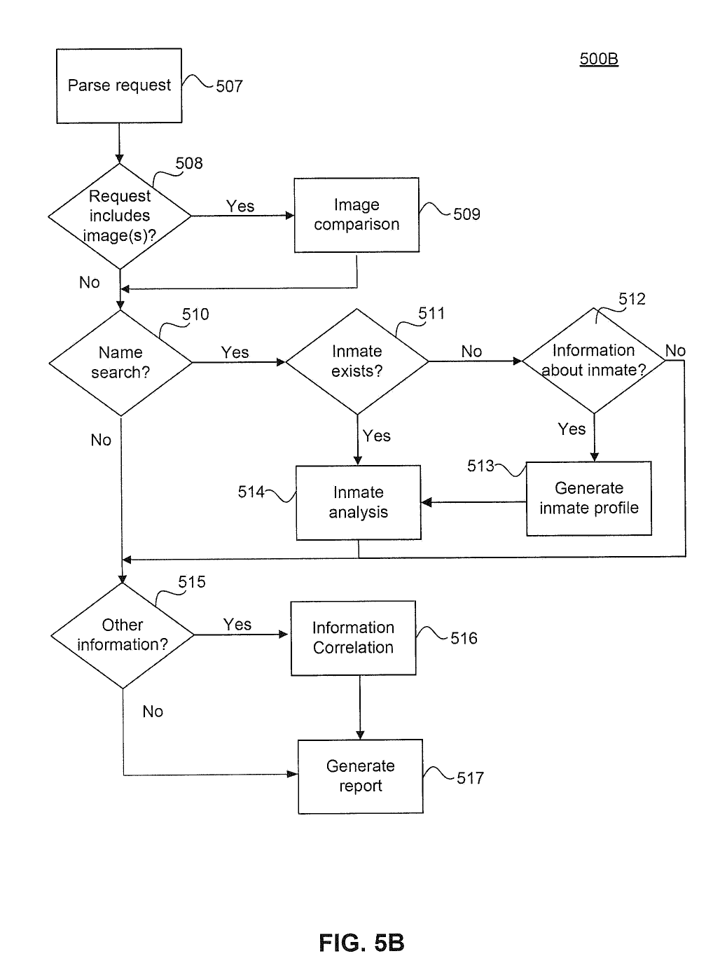

FIG. 5A illustrates a flowchart diagram of a method 500A for providing analysis of inmate information based on an investigation request from an authorized facility or official, according to embodiments of the present disclosure. In an embodiment, the method described in FIG. 5A is performed at a service center, such as one described with respect to FIG. 2. At step 501, service center provides access to an authorized facility. Service center protects the inmate information through typical authentication methods known in the art and only allows access to the information and analytical tools of the service center to authorized facilities. In an embodiment, authentication may be a secure user name/password combination although other authentication methods may be utilized.

Once an authorized facility is granted access to a service center, service center receives a request from the authorized facility at step 502. The request can include a request for information regarding a specific inmate, a request for the generation of a report, or any other type of analysis that may be pertinent to an investigation.

In order to service the received request, the service center retrieves the relevant information at step 503 and performs the requested analysis at step 504. For example, if the received request is for information with regard to a suspect in an investigation and the request includes an image of the suspect, the service center may analyze the included image, such as through facial recognition, to produce a facial identifier. Based on the produced facial identifier, the analysis engine of the service may search its database for any relevant information associated with the facial identifier. In an embodiment, the analysis engine may provide a list of names for the potential suspect as well as a confidence score which indicates the probability of identification of the names in the list to the supplied image. In another embodiment, if the request includes additional information, such as voice biometrics, physical information about the suspect, location of the crime, information other suspects, or other details of the crime, analysis engine may correlate the additional information with the list of names to increase the confidence score and therefore minimize false positives. For example, if the request includes the location of the crime, the analysis engine can parse the inmate profiles of the inmates identified in the list of names to determine whether any of the inmates on the list have previously been identified within a proximity of the location such as through the inmate's residence, a family member's residence, an associate's residence, or locations of previous crimes. If the request includes other suspects, the analysis engine can parse the inmate profiles to determine known or suspected associates of the inmates. If the request includes other details of the crimes, the analysis engine can parse the inmate profiles to compare the inmate's previous crimes with the current crime.

Based on the analysis performed by the analysis engine, service center generates report that includes the results of the analysis at step 505. For example, as discussed above, the report may include a list of names that potentially match an image included in the request. At step 506, the service center transmits the generated report to the requesting authorized facility.

FIG. 5B illustrates a flowchart diagram of a method 500B for providing analysis of inmate information based on an investigation request from an authorized facility or official, according to embodiments of the present disclosure. In particular, FIG. 5B illustrates an embodiment of the analysis that may be performed in response to receiving a request from an authorized facility. At step 507, analysis engine parses a request received from the authorized facility. At step 508, analysis engine determines whether the request includes an image or images of a suspect or suspects. If so, analysis engine performs an image comparison at step 509 between the image(s) in the request and the images stored in the database to determine any potential matches. The image comparison step can include analyzing facial architecture of the image(s) within the request to determine a unique facial identifier. The analysis engine can then utilize the unique facial identifier to search the database. Images in the database can be populated from images received from police stations (such as mug shots) or images received from prisons (such as from videos from video monitoring).

At step 510, analysis engine determines if the request includes a name or names. For example, an authorized facility can be requesting all known information regarding an inmate who is a suspect in an investigation. If so, analysis engine searches its database based on the provided name to determine whether the name exists in the database at step 511. If the inmate does not exist, analysis engine determines whether the request contains information about the inmate at step 512 and, if so, generates an a new inmate profile and populates the profile with the provided information at step 513.

At step 514, if the inmate exists, analysis engine performs the requested inmate analysis. The analysis may include retrieval of all information related to the inmate or retrieval of specific information such as a specific category of information. For example, the request can include the inmate name as well as an indication that the authorized facility is requesting all emails in which inmates have communicated with family members or other inmates. At step 515, analysis engine determines whether the request includes any other information, which can be associated with the image(s) or names included in the request. The information can include details about the crime such as location of the crime, type of crime, or victim, other suspects involved in the crime, or details about the investigation.

At step 516, analysis engine correlates the information in the request with the information in the centralized database as part of the analysis. This step can include detecting patterns of behavior of inmates, providing a list of additional suspects that may be potentially be involved in the crime or investigation, or identification of a suspect along with a list of his potential locations based on past history and associations. This correlation can be initiated based on the information provided in the request. For example, if the request includes information regarding the location of the crime and identification of the victim, analysis engine provide a list of potential suspects by searching its database to identify inmates who have been associated with the location (e.g., residence, previous crimes, family members, friends) and who may have had communications with the victims while in prison. Such analysis can employ a neural network to parse and analyze the information in the database to produce the list of suspects.

At step 517, analysis engine generates a report based on the analysis described in the previous steps.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

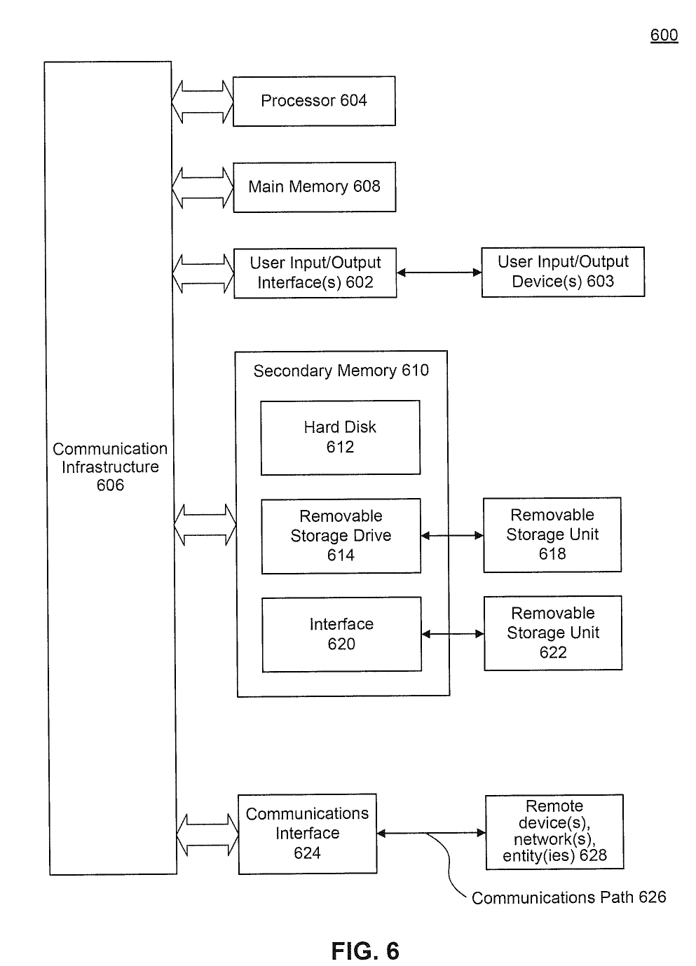

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the service center and analysis engine of FIG. 2 and the methods of FIGS. 3-4, 5A, and 5B can be implemented in the environment of one or more computer systems or other processing systems. An example of such a computer system 600 is shown in FIG. 6. One or more of the modules depicted in the previous figures can be at least partially implemented on one or more distinct computer systems 600.

Computer system 600 includes one or more processors, such as processor 604. Processor 604 can be a special purpose or a general purpose digital signal processor. Processor 604 is connected to a communication infrastructure 606 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 608, preferably random access memory (RAM), and may also include a secondary memory 610. Secondary memory 610 may include, for example, a hard disk drive 612 and/or a removable storage drive 614, representing a floppy disk drive, a magnetic tape drive, an optical disk drive, or the like. Removable storage drive 614 reads from and/or writes to a removable storage unit 618 in a well-known manner. Removable storage unit 618 represents a floppy disk, magnetic tape, optical disk, or the like, which is read by and written to by removable storage drive 614. As will be appreciated by persons skilled in the relevant art(s), removable storage unit 622 includes a computer usable storage medium having stored therein computer software and/or data.

In alternative implementations, secondary memory 610 can include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, a thumb drive and USB port, and other removable storage units 622 and interfaces 620 which allow software and data to be transferred from removable storage unit 622 to computer system 600.

Computer system 600 also includes user input/out interface(s) 602 which provide an interface to user input/output device(s) 603. Such user input/output device(s) 603 may be any device that provides a user access to input and output of computer system 600. Examples of user input/output device(s) 603 may include a keyboard, a computer monitor, a mouse, a camera, and a microphone.

Computer system 600 also includes a communications interface 624. Communications interface 624 allows software and data to be transferred between computer system 600 and external devices 628 which can include remote device(s), other network(s), and other entities. Examples of communications interface 624 can include a modem, a network interface (such as an Ethernet card), a communications port, a PCMCIA slot and card, etc. Software and data transferred via communications interface 624 are in the form of signals which can be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 618 and 622 or a hard disk installed in hard disk drive 612. These computer program products are means for providing software to computer system 600.

Computer programs (also called computer control logic) are stored in main memory 608 and/or secondary memory 610. Computer programs can also be received via communications interface 624. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using removable storage drive 614, interface 620, or communications interface 624.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the disclosure should not be limited by any of the above-described exemplary embodiments, but should be defined only in accordance with the following claims and their equivalents.

What is claimed is:

1. A centralized analysis device for receiving and generating analysis of requests, the centralized analysis device comprising:
a transceiver configured to communicate with a first communication network and a second communication network;
a communication interface with a unified database configured to store an inmate profile received from a plurality of facilities; and
a processor configured to:
receive first inmate information from a first facility through the first communication network, wherein the first inmate information includes at least a first type of data;
receive second inmate information from a second facility through the second communication network, wherein the second inmate information includes at least a second type of data;
update the at least one inmate profile in the unified database based on the first type of data and the second type of data;
receive a request from a third facility, wherein the request includes an inquiry data;
perform an analysis of the inmate profile in the unified database based on the inquiry data, wherein the analysis includes comparing the inmate profile with the inquiry data; and
generate a report based on the analysis.

2. The centralized analysis device of claim 1, wherein the first inmate information includes first biometric information of an inmate and the second information includes second biometric information of the inmate.

3. The centralized analysis device of claim 1, wherein the first inmate information includes first biometric information of a plurality of first inmates from a first prison and the second inmate information includes second biometric information of a plurality of second inmates from a second prison.

4. The centralized analysis device of claim 3, wherein the at least one inmate profile includes at least one of: emails transmitted by the plurality of first inmates, emails received by the plurality of first inmates, browsing history of the plurality of first inmates, visitation history of the plurality of first inmates, a list of parties called by the plurality of first inmates, and a list of parties who called the plurality of first inmates.

5. The centralized analysis device of claim 1, wherein the inmate information includes a collection of facial images from the first facility and the second facility and the processor is further configured to perform the step of analyzing the inmate information including:
determine that the inquiry data includes a facial image;
perform a match operation between the facial image and the collection of facial images; and
output a result based on a result of the match operation.

6. The centralized analysis device of claim 1, wherein the processor is further configured to perform the analysis including:
determine that the inquiry data includes at least one detail regarding a crime;
search the database for the at least one detail;
correlate the at least one detail with the inmate information within the unified database;
determine a set of correlated inmate information based on the at least one detail and the inmate information; and
provide the set of correlated inmate information.

7. The centralized analysis device of claim 1, wherein the processor is further configured to:
authenticate the first facility, the second facility, and the third facility;
determine a first access capability of the first facility;
determine a second access capability of the second facility;
determine a third access capability of the third facility, wherein the first access capability, the second access capability, and the third access capability include one of a read access capability for the unified database, a write access capability for the unified database, and a read/write access capability for the unified database;
provide access to the first facility based on the first access capability;
provide access to the second facility based on the second access capability; and
provide access to the third facility based on the third access capability.

8. The centralized analysis device of claim 1, wherein the first facility and second facility are different types of facilities.

9. A centralized analysis device for receiving and generating analysis of requests, the centralized analysis device comprising:
a transceiver configured to communicate with a communication network;
a communication interface configured to communicate with a database storing an inmate profile received from a plurality of facilities; and
a processor configured to:
receive first inmate information from a first facility through the first communication network, wherein the first inmate information includes a first inmate profile generated by the first facility;
receive second inmate information from a second facility through the second communication network, wherein the second inmate information includes a type of data;
store the first inmate profile in the unified database
update the inmate profile in the unified database based on the type of data;
receive a request from a third facility, wherein the request includes an inquiry data;
perform an analysis of the inmate profile based on the inquiry data, wherein the analysis includes comparing the inmate profile with the inquiry data; and
generate a report based on the analysis.

10. The centralized analysis device of claim 9, wherein the first inmate information includes first biometric information of an inmate and the second information includes second biometric information of the inmate.

11. The centralized analysis device of claim 9, wherein the first inmate information includes first biometric information of a plurality of first inmates from a first prison and the second inmate information includes second biometric information of a plurality of second inmates from a second prison.

12. The centralized analysis device of claim 11, wherein the inmate profile includes at least one of: emails transmitted by the plurality of first inmates, emails received by the plurality of first inmates, browsing history of the plurality of first inmates, visitation history of the plurality of first inmates, a list of parties called by the plurality of first inmates, and a list of parties who called the plurality of first inmates.

13. The centralized analysis device of claim 9, wherein the inmate information includes a collection of facial images from the first facility and the second facility and the processor is further configured to perform the step of analyzing the inmate information including:
determine that the inquiry data includes a facial image;
perform a match operation between the facial image and the collection of facial images; and
output a result based on a result of the match operation.

14. The centralized analysis device of claim 9, wherein the processor is further configured to perform the step of analyzing the inmate information including:
determine that the inquiry data includes at least one detail regarding a crime;
search the database for the at least one detail;
correlate the at least one detail with the inmate information within the unified database;
determine a set of correlated inmate information based on the at least one detail and the inmate information; and
provide the set of correlated inmate information.

15. The centralized analysis device of claim 9, wherein the processor is further configured to:
authenticate the first facility, the second facility, and the third facility;
determine a first access capability of the first facility;
determine a second access capability of the second facility;
determine a third access capability of the third facility, wherein the first access capability, the second access capability, and the third access capability include one of a read access capability for the unified database, a write access capability for the unified database, and a read/write access capability for the unified database;
provide access to the first facility based on the first access capability;
provide access to the second facility based on the second access capability; and
provide access to the third facility based on the third access capability.

16. A method for detecting and monitoring a target device used in a facility, the method comprising:
receiving first inmate information from a first facility through the first communication network, wherein the first inmate information includes at least a first type of data;
determining that the first inmate information relates to a first inmate;
generating a first inmate profile based on the first inmate information, wherein the first inmate profile includes the first type of data;
receiving second inmate information from a second facility through the second communication network, wherein the second inmate information includes at least a second type of data;
determining that the second inmate information relates to a second inmate;
generating a second inmate profile based on the second inmate information, wherein the second inmate profile includes the second type of data;
storing the first inmate profile and the second inmate profile in the unified database;
receiving a request from a third facility, wherein the request includes an inquiry data;
performing an analysis of the first inmate profile and the second inmate profile in the unified database based on the inquiry data, wherein the analysis includes comparing the first inmate profile and the second inmate profile with the inquiry data; and
generate a report based on the analysis of the first inmate profile and the second inmate profile.

17. The method of claim 16, wherein the first inmate information includes first biometric information of an inmate and the second information includes second biometric information of the inmate.

18. The method of claim 16, wherein the first inmate information includes first biometric information of a plurality of first inmates from a first prison and the second inmate information includes second biometric information of a plurality of second inmates from a second prison.

19. The method of claim 18, wherein the first inmate profile includes at least one of: emails transmitted by the plurality of first inmates, emails received by the plurality of first inmates, browsing history of the plurality of first inmates, visitation history of the plurality of first inmates, a list of parties called by the plurality of first inmates, and a list of parties who called the plurality of first inmates.

20. The method of claim 16, wherein the first inmate profile and second inmate profile include a collection of facial images from the first facility and the method further comprising:
determining that the inquiry data includes a facial image;
performing a match operation between the facial image and the collection of facial images; and
outputting a result based on a result of the match operation.
